(19) United States
(12) Patent Application Publication
(10) Pub. No.: US 2024/0033758 A1
(43) Pub. Date: Feb. 1, 2024

(54) Garden sprayer with a handle positioning structure

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 17/876,500

(22) Filed: Jul. 28, 2022

(51) Int. Cl. B05B 9/01

(52) U.S. Cl. CPC B05B 9/01

(57) ABSTRACT

A garden sprayer with a handle positioning structure has a main body, a grip, and a buckle. The main body comprises a handle and an output tube with a positioning ring. The grip is mounted on the main body and configured for controlling water, and the grip has a pressing surface with a groove. The groove has a stopping edge respectively on each opposite side walls and two first positioning notches respectively disposed opposite the two stopping edges. The two first positioning notches are spaced from each other. The buckle has a stopping block with two engaging claws on two opposing back sides, the two engaging claws are spaced by a gap, and each of the two engaging claws having a second positioning notch.

### BACKGROUND OF INVENTION

### Field of Invention

The present invention relates to a garden sprayer and more particularly to a garden sprayer with a handle positioning structure.

### Description of the Related Art

In common gardening work, it is necessary to water the flowers, plants and trees frequently to avoid the death of the plants due to lack of water. When the planting range of the plants is wider, or the distance from the water source is far, it is necessary to use the extension of the water hose, but the intensity of the water directly flowing from the water hose is strong and limited, so it is not useful and it is necessary to install a sprayer at the end of the water pipe. Water spray guns are capable to spray water in a large area to achieve more efficient and comprehensive irrigation.

Conventional water spray guns required the pressing pressure of the grip to control the water flow, and user's fingers must hold the grip tightly when in use. Otherwise, once the pressure is released, the grip immediately bounces back and stop the water. When the fingers are pressing for a long time, hand fatigue and soreness can happen. There is another type of water spray gun, after the grip is pressed, the buckle is used to hold on the grip, so that the spray gun can continuously discharge water, but it still needs both hands to operate at the same time, so there are still concerns about poor convenience in use.

Therefore, it is desirable to provide a garden sprayer with a handle positioning structure to mitigate and/or obviate the aforementioned problems.

### SUMMARY OF THE INVENTION

An objective of present invention is to provide a garden sprayer with a handle positioning structure which is capable of improving the above-mention problems.

In order to achieve the above mentioned objective, A garden sprayer with a handle positioning structure has a main body, a grip, and a buckle. The main body comprises a handle and an output tube with a positioning ring. The grip is mounted on the main body and configured for controlling water, and the grip has a pressing surface with a groove. The groove has a stopping edge respectively on each opposite side walls and two first positioning notches respectively disposed opposite the two stopping edges. The two first positioning notches are spaced from each other. The buckle has a stopping block with two engaging claws on two opposing back sides, the two engaging claws are spaced by a gap, and each of the two engaging claws having a second positioning notch.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combined drawing according to an embodiment of the present invention.

FIG. 2 is a three-dimensional exploded view according to the embodiment of the present invention.

FIG. 3 is a partial enlarged and exploded view according to the embodiment of the present invention.

FIG. 4 is the combined plan view according to the embodiment of the present invention.

FIG. 5 is a partial enlarged view according to the embodiment of the present invention.

FIG. 6 is a cross-sectional view according to the embodiment of the present invention.

FIG. 7 is another cross-sectional view from another angle according to the embodiment of the present invention.

FIG. 8 shows the grip being pressed according to the embodiment of the present invention.

FIG. 9 shows the buckle being pushed upward movement according to the embodiment of the present invention.

FIG. 10 shows the buckle being locked after it was moved up according to the embodiment of the present invention.

FIG. 11 shows the grip being fixed at outputting position according to the embodiment of the present invention.

### DETAILED DESCRIPTION OF THE PREFERRED EMBODIMENT

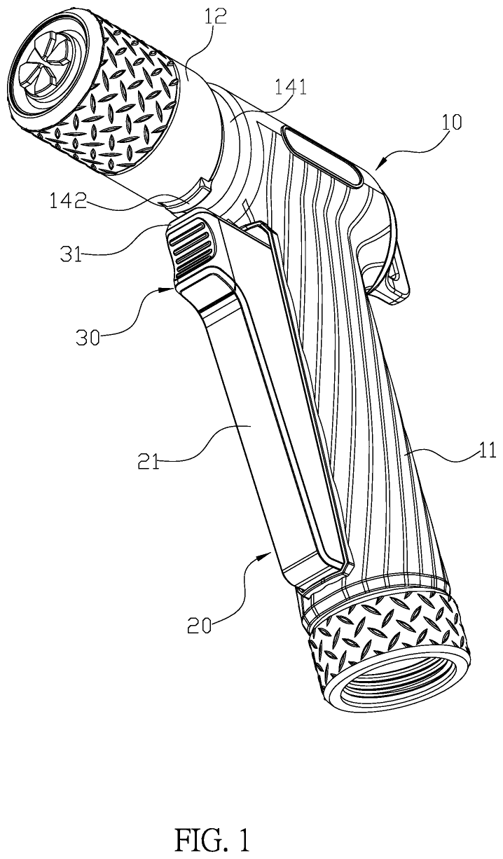

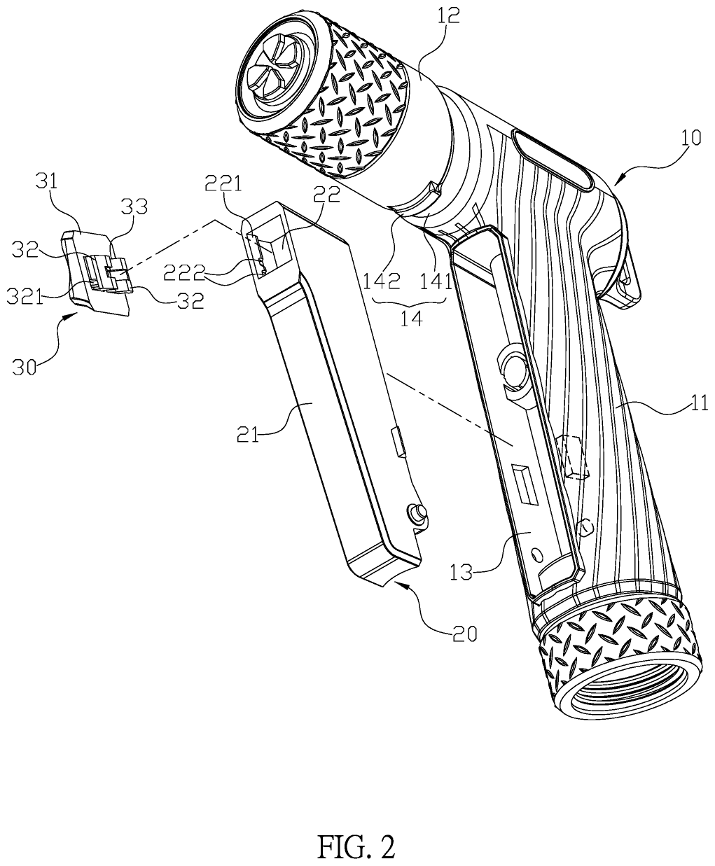

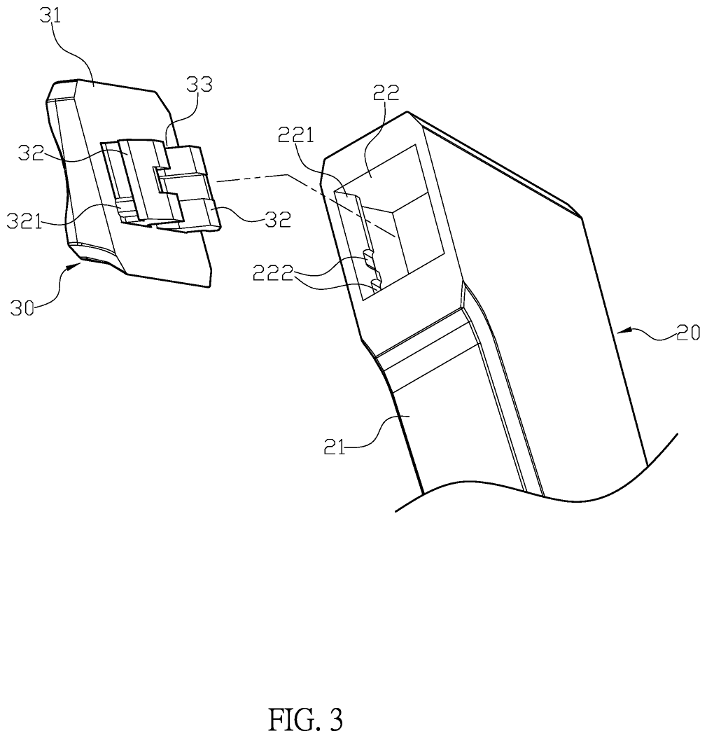

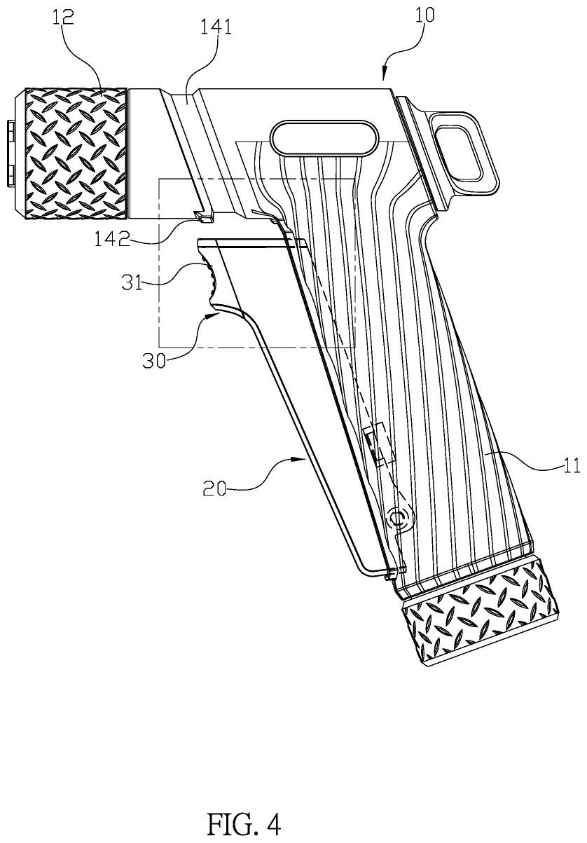

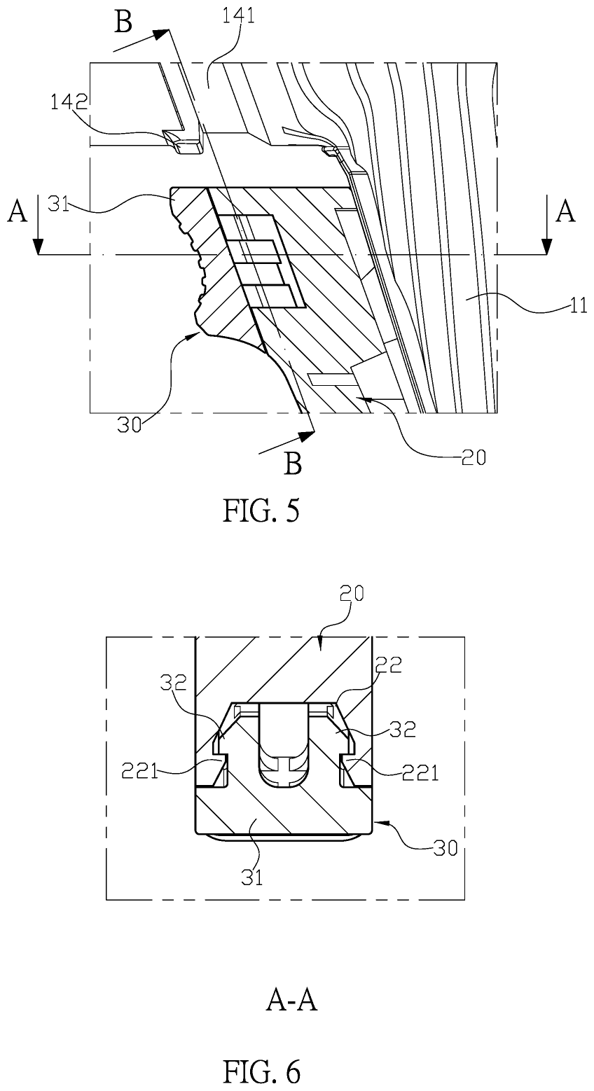

First, please refer to FIG. 1 to FIG. 7. A garden sprayer with a handle positioning structure comprises: a main body 10, a grip 20 and a buckle 30. The main body 10 has a handle 11 with a controlling chamber 13 and an output tube 12 with a positioning ring 14. The grip 20 is mounted in the controlling chamber 13 and has a pressing surface 21 protruding from the controlling chamber 13 such that the main body 10 is capable of for controlling water to be output from the output tube 12. The pressing surface 21 further has a groove 22, the groove 22 has a stopping edge 221 respectively on each opposite side walls and two first positioning notches 222 respectively disposed opposite the two stopping edges 221, and the two first positioning notches 222 are spaced from each other acting as two different control modes. The buckle 30 has a stopping block 31 with two engaging claws 32 on two opposing back sides, and the two engaging claws 32 are spaced by a gap 33. Each of the two engaging claws 32 has a second positioning notch 321, when the engaging claws 32 of the buckle 30 are pushed into the groove 22, the engaging claws 32 and the stopping edges 221 push against each other which limits the buckle 30 on the handle 11 within the groove 22. Furthermore, when the buckle 30 is pushed upwardly, with a top edge of the stopping block 31 and the positioning ring 14, the grip 20 maintains being pressed down. The movements of the second positioning notch 321 between the two first positioning notches 222 allows the buckle 30 to be positioned up and down securely.

In addition, an elastic member is disposed between the controlling chamber 13 and the grip 20 and pushes the grip 20.

Moreover, the positioning ring 14 is a ring groove 141.

Furthermore, the positioning ring 14 is a stopping rib 142 protruding from a surface of the output tube 12.

Additionally, the positioning ring 14 comprises the ring groove 141 and a stopping rib 142.

Also, each stopping edge 221 has an inclined surface, and each engaging claw 32 is pushed into the groove 22.

Correspondingly, the first positioning notches 222 and the second positioning notches 321 are pairs of corresponding grooves and ribs.

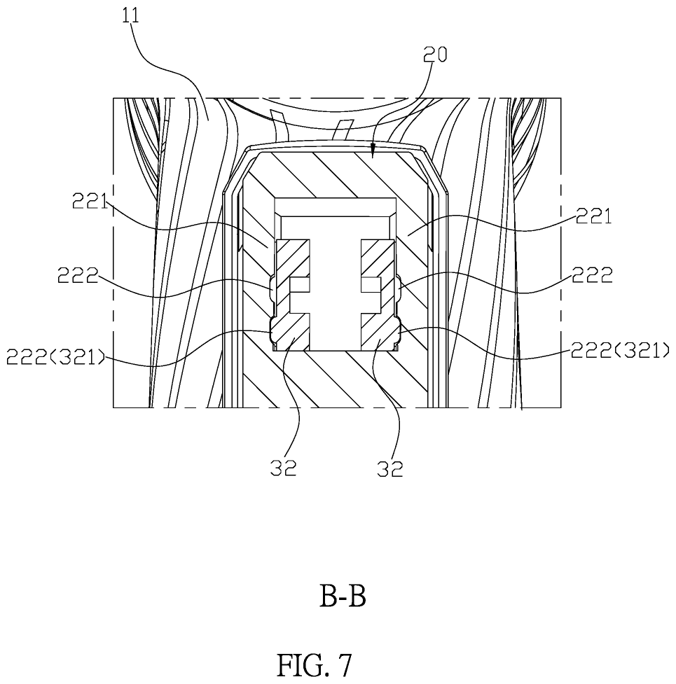

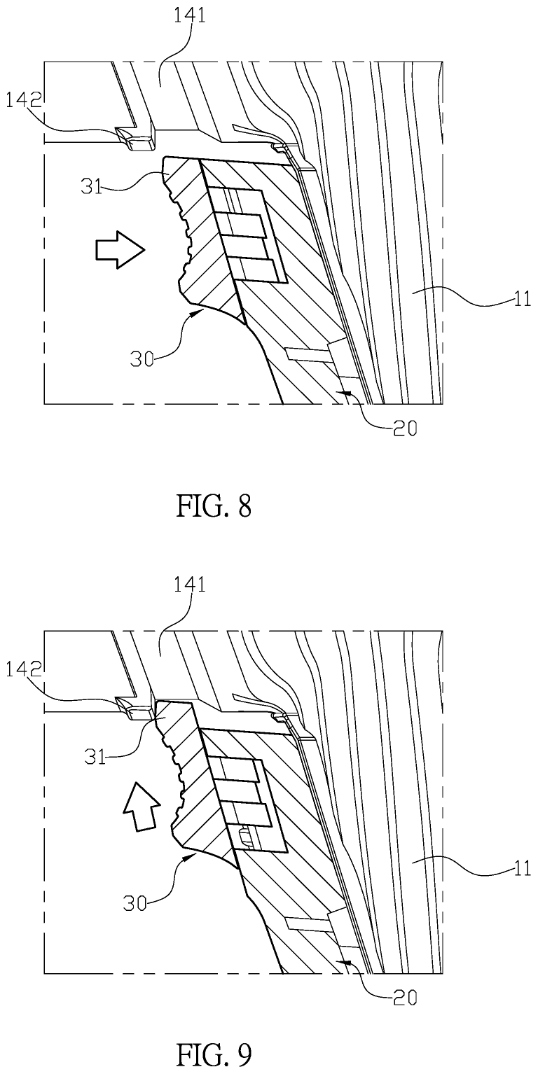

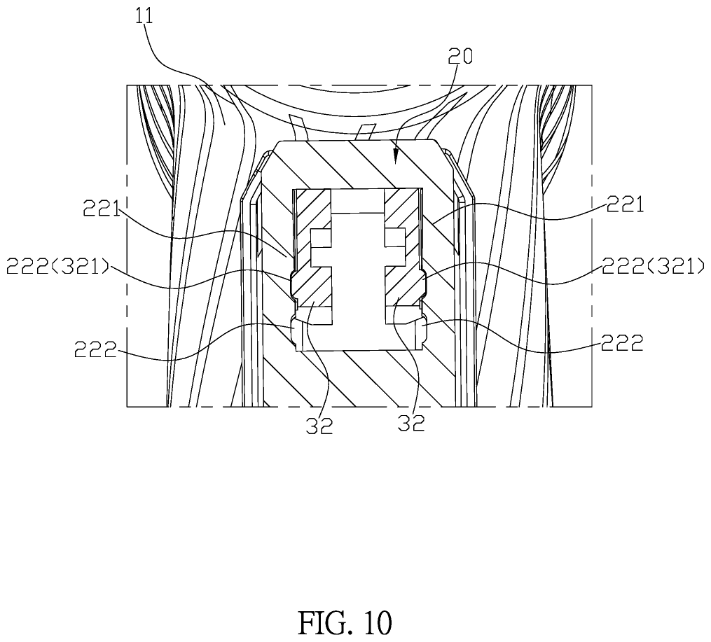

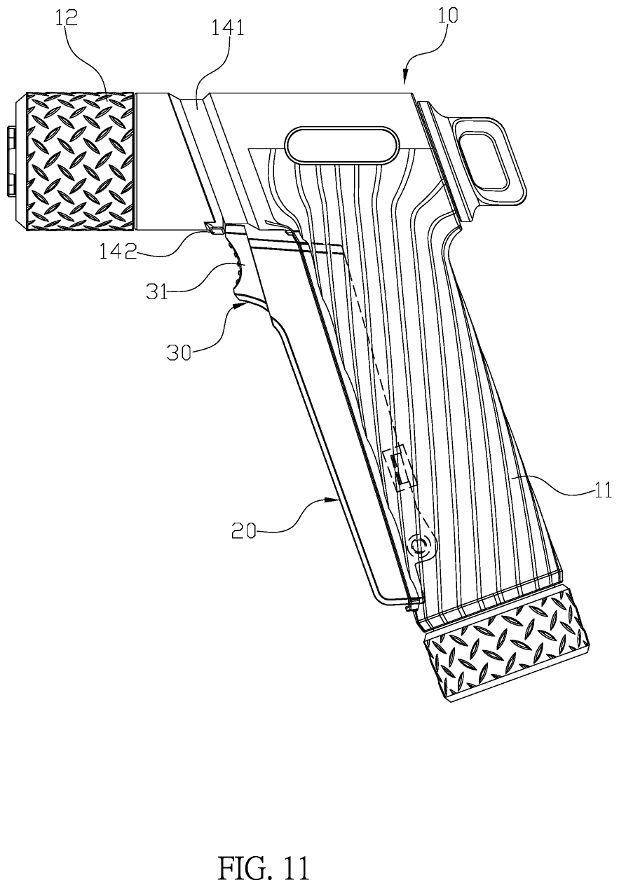

During the actual use, as shown in FIG. 8, the grip 20 is pressed to control the main body 10 to output water; after the grip 20 is pressed, the buckle 30 can be pushed up to make the top edge of the stopping block 31 to engage with the positioning ring 14, as shown in FIG. 9 and FIG. 11. As above-mentioned, the grip 20 is not required to be pressed all the time but can still keep outputting water continuously, and the buckle 30 can be operated by one single hand, which will be more convenient to use. By engaging the second positioning notches 321 and the first positioning notches 222 at the upper and lower positions respectively, the buckle 30 can obtain sufficient positioning in the two positions, as shown in FIG. 7 and FIG. 10.

Although the present invention has been explained in relation to its preferred embodiment, it is to be understood that many other possible modifications and variations can be made without departing from the spirit and scope of invention as hereinafter claimed.

What is claimed is:

1. A garden sprayer with a handle positioning structure comprising: a main body, a grip, and a buckle; wherein:
the main body comprises a handle and an output tube with a positioning ring;
the grip is mounted on the main body and configured for controlling water, the grip comprising a pressing surface with a groove, the groove comprising a stopping edge respectively on each opposite side walls and two first positioning notches respectively disposed opposite the two stopping edges, the two first positioning notches spaced from each other;
the buckle has a stopping block with two engaging claws on two opposing back sides, the two engaging claws spaced by a gap, each of the two engaging claws having a second positioning notch; wherein when the engaging claws of the buckle are pushed into the groove, the engaging claws and the stopping edges push against each other which limits the buckle on the handle within the groove; and when the buckle is pushed upwardly, with a top edge of the stopping block and the positioning ring, the grip maintains being pressed down.

2. The garden sprayer with a handle positioning structure as claimed in claim 1, wherein a controlling chamber is disposed in front of the handle for accepting the grip.

3. The garden sprayer with a handle positioning structure as claimed in claim 2, wherein an elastic member is disposed between the controlling chamber and the grip and pushes the grip.

4. The garden sprayer with a handle positioning structure as claimed in claim 1, wherein the positioning ring is a ring groove.

5. The garden sprayer with a handle positioning structure as claimed in claim 1, wherein the positioning ring is a stopping rib protruding from a surface of the output tube.

6. The garden sprayer with a handle positioning structure as claimed in claim 1, wherein the positioning ring comprises the ring groove and a stopping rib.

7. The garden sprayer with a handle positioning structure as claimed in claim 1, wherein each stopping edge has an inclined surface, and each engaging claw is pushed into the groove.

8. The garden sprayer with a handle positioning structure as claimed in claim 1, wherein the first positioning notches and the second positioning notches are pairs of corresponding grooves and ribs.
